(19) United States
(12) Patent Application Publication
(10) Pub. No.: US 2003/0010829 A1
(43) Pub. Date: Jan. 16, 2003

(54) Methods and apparatus for arranging flash memory cards

(76) Inventor: Marcelo Krygier, Kyriat Ono (IL)

Correspondence Address: Eitan, Pearl, Latzer & Cohen-Zedek, One Crystal Park, Suite 210, 2011 Crystal Drive, Arlington, VA, 22202-3709, US

(21) Appl. No.: 09/902,578

(22) Filed: Jul. 12, 2001

(51) Int. Cl. G06K 19/00

(52) U.S. Cl. 235/487

(57) ABSTRACT

Apparatus including a flash memory card formed with a hole therethrough, the hole being adapted for passing a string therethrough.

### FIELD OF THE INVENTION

The present invention relates generally to flash memory cards, such as the MultiMediaCard (MMC), and methods and apparatus for arranging, storing and carrying such cards.

### BACKGROUND OF THE INVENTION

Small removable mass storage devices, constructed in the form of flash memory cards, are well known in the art. Flash memory cards, also referred to simply as flash cards, generally comprise non-volatile flash memories, and have become increasingly popular for use with digital cameras and digital music players, as well as smart cellular phones.

One well-known kind of flash card is the “CompactFlash™” card, which is particularly popular for use with digital cameras. CompactFlash was first introduced in 1994 by SanDisk Corporation, The size of a CompactFlash card is typically 43 mm×36 mm×3.3 mm. The CompactFlash card typically has 50 pins, as opposed to a 68-pin PCMCIA (Personal Computer Memory Card International Association) card, and is about one-fourth the volume of the PCMCIA card. Yet the CompactFlash card may provide complete PCMCIA functionality and compatibility.

Another type of flash memory card with similar dimensions is the Solid State Floppy Disk Card (SSFDC), also called a SmartMediaCard (e.g., SMC made by Toshiba). Yet another type of flash memory device is the “MemoryStick™” made by Sony, which may be used with digital cameras for additional storage. It uses a 10-pin connector and uses a serial data transfer method to move the data. It typically operates at 2.7 V to 3.6 V, and has dimensions of about 21.5 mm×50 mm×2.8 mm.

Another popular flash memory card is the MultiMediaCard (MMC) made by Siemens/SanDisk. The MMC is even smaller than the aforementioned cards, typically being the size of a postage stamp. For example, a 32 MB MultiMedia Card commercially available from SanDisk measures 32 mm×24 mm×1.2 mm, and weighs less than 1.5 g. It operates at 2.7 to 3.6 volts, and may be used with cellular phones, PDAs (Personal Digital Assistants), music players and electronic organizers. Smaller size MMCs are also available.

Yet another type of flash memory card is the Secure Digital (SD) card from San Disk. SD cards are similar in shape to MMC cards, but thicker, such as about 2.1 mm thick.

Flash memory cards have several advantages over conventional magnetic disk drives. Because these cards comprise nonvolatile memory, they do not require a battery to retain data indefinitely. The cards are solid state, meaning they contain no moving parts, and provide users with much greater protection of their data than conventional magnetic disk drives. They are much more rugged and reliable than disk drives, and consume a fraction (typically only about five percent) of the power required by small disk drives.

Small flash memory cards, especially the MMC, are typically stored and carried in plastic or metal pouches or cases with pockets for slipping the cards therein.

### SUMMARY OF THE INVENTION

The present invention seeks to provide improved methods and apparatus for arranging, storing and carrying flash memory cards, such as the MMC. In the present invention, a hole is formed through a portion of the flash memory card package. A string may be threaded through the hole. In this manner, a multiplicity of the flash memory cards may be conveniently carried and stored, all strung together on a common string or on a plurality of strings.

The term string, as used throughout the disclosure, refers to any kind of thin element, flexible or non-flexible, suitable for passing through a hole and supporting the weight of the flash memory cards, such as but not limited to, string, cord, lanyard, thread, filament, connected beads, rubber bands key ring or key chain, and the like.

There is thus provided in accordance with a preferred embodiment of the present invention apparatus including a flash memory card formed with a hole therethrough, the hole being adapted for passing a string therethrough. The string preferably at least partially passes through the hole.

In accordance with a preferred embodiment of the present invention a plurality of the flash memory cards are provided and a string at least partially passes through holes of at least two of the flash memory cards.

Further in accordance with a preferred embodiment of the present invention the flash memory card includes at least one of a CompactFlash™ card, a MemoryStick™, a MultiMediaCard (MMC), a Solid State Floppy Disk Card (SSFDC), a Secure Digital (SD) card and a SmartMediaCard (SMC).

There is also provided in accordance with a preferred embodiment of the present invention a method including forming a hole through a flash memory card, the hole being adapted for passing a string therethrough.

### BRIEF DESCRIPTION OF THE DRAWINGS

The present invention will be understood and appreciated more fully from the following detailed description taken in conjunction with the appended drawings in which:

FIG. 1 is a simplified pictorial illustration of a flash memory card formed with a carrying hole, in accordance with a preferred embodiment of the present invention; and

FIG. 2 is a simplified pictorial illustration of a plurality of flash memory cards strung on a string, in accordance with a preferred embodiment of the present invention.

### DETAILED DESCRIPTION OF THE PRESENT INVENTION

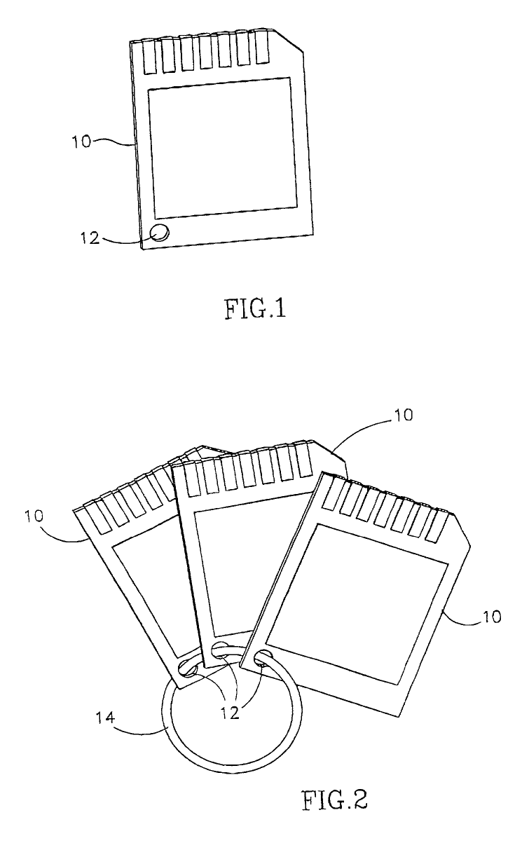

Reference is now made to FIGS. 1 and 2, which illustrate a flash memory card 10 formed with a hole 12 therethrough. Flash memory card 10 may be any size or form of flash memory card, such as but not limited to, a MultiMediaCard (MMC), a CompactFlash™ card, a MemoryStick™, a Solid State Floppy Disk Card (SSFDC), a SmartMediaCard (SMC) and a Secure Digital (SD) card, Hole 12 may be of any size and shape and may be placed anywhere on the package of the flash memory card 10, preferably without interfering with the electronic or mechanical functionality of the card. Hole 12 may be formed in any suitable manner, such as but not limited to, by drilling or coring, or as an integral part of the package forming process of the card 10.

A string 14 passes at least partially through hole 12. As seen in FIG. 2, a plurality of flash memory cards 10 may be conveniently carried and stored, strung together on one or more strings 14.

It will be appreciated by person skilled in the art, that the present invention is not limited by what has been particularly shown and described herein above. Rather the scope of the present invention is defined only by the claims that follow:

What is claimed is

1. Apparatus comprising:
a flash memory card formed with a hole therethrough, the hole being adapted for passing a string therethrough.

2. Apparatus according to claim 1 and further comprising a string that at least partially passes through said hole.

3. Apparatus according to claim 1 and further comprising a plurality of said flash memory cards and a string that at least partially passes through holes of at least two of said flash memory cards.

4. Apparatus according to claim 1 wherein said flash memory card comprises at least one of a CompactFlash™ card, a MemoryStick™, a MultiMediaCard (MMC), a Solid State Floppy Disk Card (SSFDC), a SmartMediaCard (SMC) and a Secure Digital (SD) card.

5. A method comprising:
forming a hole through a flash memory card, the hole being adapted for passing a string therethrough.

6. The method according to claim 5 and further comprising at least partially passing a string through said hole.

7. The method according to claim 5 and further comprising providing a plurality of said flash memory cards, and at least partially passing a string through holes of at least two of said flash memory cards.

8. The method according to claim 5 wherein said forming comprises forming a hole in at least one of a CompactFlash™ card, a MemoryStick™, a MultiMediaCard (MMC), a Solid State Floppy Disk Card (SSFDC), a SmartMediaCard (SMC) and a Secure Digital (SD) card.
